(19) United States
(12) Patent Application Publication
(10) Pub. No.: US 2025/0197625 A1
(43) Pub. Date: Jun. 19, 2025

(54) Tack-Free Properties of Light-Curable Compositions

(71) Applicant: Henkel AG & Co. KGaA, Duesseldorf (DE)

(72) Inventors: Andrew D. Messana, Newington, CT (US); Darryl J. Small, Coventry, CT (US)

(21) Appl. No.: 19/068,437

(22) Filed: Mar. 3, 2025

Related U.S. Application Data
(63) Continuation of application No. PCT/US2023/072797, filed on Aug. 24, 2023.
(60) Provisional application No. 63/374,404, filed on Sep. 2, 2022.

(51) Int. Cl. C08L 33/10; C08L 83/06

(52) U.S. Cl. CPC C08L 33/10; C08L 83/06

(57) ABSTRACT

Disclosed are tack lessening components and methods of their use. The tack lessening components provide a broad range of radiation curable compositions with a cured surface having lessened tack. The tack lessening agents are used in very low levels within the radiation curable composition and comprises an acrylate functionalized polydimethylsiloxane, optionally in diacrylate monomer or a non-acrylate functionalized polydimethylsiloxane, optionally in diacrylate monomer.

### FIELD

The present disclosure relates generally to radiation curable compositions and more particularly to radiation curable compositions having little or no tackiness after radiation curing.

### BRIEF DESCRIPTION OF RELATED TECHNOLOGY

Radiation curable compositions are well known for use as adhesives, sealants and coatings. These compositions generally comprise oligomers or polymers having (meth)acrylate functional groups; diluent; optionally one or more photoinitiators and other optional additives. Depending on the formulation the uncured composition can be a liquid to viscous liquid. These compositions are cured by exposure to actinic radiation after application to a substrate. Depending on the formulation the cured composition can range from a desirably tacky or sticky pressure sensitive adhesive to a desirably non-tacky hard structural composition such as an adhesive, sealant or coating.

Improving the tack-free properties of a curable composition can be highly desired since it leads to greater user acceptance in applications where tackiness of the cured composition may slow or prevent a part/assembly from being moved to the next operation or storage. Further, users often perceive tackiness of a cured composition as being indicative of as a ‘lack of cure’ or ‘under-cure’ of the radiation cured composition in the application. This is particularly important along exposed bond-lines, for example where ‘under-cured’ adhesive may be in critical contact with fluids such as saline solution.

However, achieving tack-free properties with radiation curable compositions is challenging. Formulation of the various acrylate monomer and acrylate-functional resin combinations with photo-initiator levels and systems tend to impart desired cured composition characteristics such as strength or hardness can fuel a tendency of the cured composition toward tacky cured surfaces. Also, the move to LED radiation sources to cure compositions can leave the cured composition tacky. LED radiation sources emit in a narrow range centered around a higher wavelength (such as 365 nm, 385 nm or 405 nm) while older mercury vapor and meatal halide sources emit over a much broader range of ultraviolet wavelengths, including the more energetic shorter wavelengths, with a plurality of emission peak wavelengths. For some radiation curable compositions, the broad spectrum sources provide better (less or no) tack properties compared to narrow spectrum LED sources.

A radiation curable composition that achieves a low tack or tack-free state remains desirable. This is especially important where the composition is an adhesive or coating that also needs ‘dry-to-the-touch’ coating-like properties. This is also important when radiation exposure times are very short. Radiation curable adhesives are conventionally exposed to radiation for about 5 to 20 seconds at an irradiance of about 1,000 mW/cm² (about 5,000 to 20,000 mJ/cm²) to ensure a desired level of curing. Achieving a low tack or tack-free property when the radiation exposure time is very short, such as 1 second or less, is exceedingly difficult. Additives that can improve the appearance by reducing surface tackiness of existing compounds to are also desirable.

Properties of the uncured radiation curable composition are also important. The uncured composition must have a viscosity suitable for its intended application. In some applications using pressurized dispensing a viscous material is suitable and me even be preferable. In other applications using wicking or drop applications a low viscosity composition is required.

Properties of the cured composition are further important and must be matched to the application. A cured adhesive bonding rigid materials requires little flexibility while a cured adhesive bonding flexible materials must have substantial flexibility to avoid cracking in use. Typically, it is desirable for adhesives to have high bond strength to the parts being bonded and conventionally it is desirable for the part being bonded to fail before the adhesive bond.

### SUMMARY

One aspect of the disclosure provides a radiation curable composition that cures to a low tack or tack-free state.

One aspect of the disclosure provides a radiation curable composition that cures to a low tack or tack-free state even after very short exposures to radiation.

Another aspect of the disclosure provides one or more components that can be added at very low levels to a radiation curable composition to lessen tackiness of that cured composition.

Another aspect of the disclosure provides for use of very low levels of an acrylate functionalized polydimethylsiloxane copolymer component or non-acrylate functionalized polydimethylsiloxane copolymer component that can be added at very low levels to a radiation curable composition to lessen tackiness of that cured composition.

### BRIEF DESCRIPTION OF THE DRAWINGS

Referring now to the drawings wherein like elements are numbered alike in the several Figures:

FIG. 1 is a graph of tack rating for different compositions with and without tack lessening agents.

FIG. 2 is a graph of tack rating for different compositions with and without tack lessening agents.

FIG. 3 is a graph of tack rating for different compositions with and without tack lessening agents.

FIG. 4 is a graph of tack rating for different compositions with and without tack lessening agents.

FIG. 5 is a graph of tack rating for different commercial compositions with and without tack lessening agents.

FIG. 6 is a graph of tack rating for different commercial compositions with and without tack lessening agents.

FIG. 7 illustrates tack test standards for actinically cured samples of the disclosed composition.

### DETAILED DESCRIPTION

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

The terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

The molecular weights given in the present text refer to number average molecular weights (Mn), unless otherwise stipulated. Molecular weight data can be obtained by gel permeation chromatography (GPC) calibrated against polystyrene standards in accordance with DIN 55672-1:2007-08 at 35° C., unless otherwise stipulated. The weight average molecular weight M_{w} can be determined by GPC, as described for Mₙ. “Polydispersity index” refers to a measure of the distribution of molecular mass in a given polymer sample. The polydispersity index is calculated by dividing the weight average molecular weight (Mw) by the number average molecular weight (Mn).

As used herein a curable, one component (1K) composition is a singular formulation that has sufficient commercial stability to be prepared, warehoused and shipped to an end user. The 1K composition can be used without adding any additional components and will crosslink or cure when exposed to suitable conditions. As used herein a two component (2K) composition has two or more components. Each of the components is prepared, warehoused and shipped separately from the other components. The components are mixed immediately prior to use. Mixing of the components starts a cure reaction so commercial storage after mixing is not possible.

(Meth)acrylate refers to at least one of acrylate and methacrylate. A “vinyl group” refers to (CH₂═CH—). A “(meth)acryloyl” refers to at least one of acryloyl and methacryloyl group. An “acryloyl group” refers to (CH₂═CHCO—). A “methacryloyl group” refers to (CH₂═C(CH₃)CO—).

“Acyl” refers to the general formula —C(O)alkyl.

“Aliphatic” means saturated or unsaturated, straight, branched or cyclic hydrocarbon groups.

“Alkenyl” or “lower alkenyl” refers to a linear, branched or cyclic carbon chain having from 1 to about 16 carbon atoms, and advantageously about 1 to about 6 carbon atoms, and at least one double bond between carbon atoms in the chain. Examples include, for example, ethylene, allene, butene, butadiene, hexene, hexadiene, 5,5-dimethyl-1-hexene and cyclohexene. Unless otherwise specifically limited an alkenyl group can be unsubstituted, singly substituted, or multiply substituted, with substituent groups in any possible position.

“Alkoxy” refers to the general formula —O-alkyl.

“Alkyl” refers to a linear, branched or cyclic alkyl group having from 1 to about 9 carbon atoms including, for example, methyl, ethyl, propyl, butyl, hexyl, octyl, isopropyl, isobutyl, tert-butyl, cyclopropyl, cyclohexyl, cyclooctyl, vinyl and allyl. Unless otherwise specifically defined, an alkyl group can be saturated or unsaturated and substituted or unsubstituted. Unless otherwise specifically limited, a cyclic alkyl group includes monocyclic, bicyclic and polycyclic rings, for example norbornyl, adamantyl and related terpenes.

“Alkylamino” refers to the general formula —(NH)-alkyl.

“Di-alkylamino” refers to the general formula —N-(alkyl).sub.2. Unless otherwise specifically limited di-alkylamino includes cyclic amine compounds such as piperidine and morpholine.

The terms “aromatic” or “aryl” means cyclic conjugated hydrocarbon structures (C₁₋₁₂) which may optionally be substituted.

“Aroyl” refers to the general formula —C(═O)-aryl.

Free or substantially free as used herein refers to the presence of less than 10%, preferably less than 5%, more preferably less than 1% and even more preferably no more than a trace or impurity amount or 0%.

“Halogen,” “halo” or “hal” when used alone or as part of another group mean chlorine, fluorine, bromine or iodine.

Room temperature refers a temperature of about 25° C.

“Radiation” refers to actinic radiation including electron beam radiation and radiation in the ultraviolet (UV-A, UV-B and UV-C), visible and infrared wavelengths.

The term substituted means substituted by at least one below described substituent group in any possible position or positions. Substituent groups for the above moieties useful in the disclosed compounds are those groups that do not significantly diminish the biological activity of the disclosed compound. Substituent groups that do not significantly diminish the desired activity of the disclosed compound include, for example, H, halogen, N₃, NCS, CN, NO₂, NX₁X₂, OX₄, C(X₄)₃, OAc, O-acyl, O-aroyl, NH-acyl, NH-aroyl, NHCOalkyl, CHO, C(halogen)₃, COOX₄, SO₃H, PO₃H₂, SO₂NX₁X₂, CONX₁X₂, C(O)CF₃, alkyl(C₁₋₈), alkoxy, alkylmercapto, alkylamino, di-alkylamino, aryl, alkaryl, sulfonamide or thioalkoxy wherein X₁ and X₂ each independently comprise H or alkyl, or X₁ and X₂ together comprise part of a heterocyclic ring having about 4 to about 7 ring members and optionally one additional heteroatom selected from O, N or S, or X₁ and X₂ together comprise part of an imide ring having about 5 to about 6 members and X₄ comprises H, alkyl, lower alkylhydroxy, or alkyl-NX₁X₂. Unless otherwise specifically limited, a substituent group may be in any possible position or any possible positions if multiply substituted.

The term “oligomer” means a defined, small number of repeating monomer units such as 10 to 5,000 units, and desirably 10-100 units which have been polymerized to form a molecule and is a species of the term polymer. The term “resin” also describes a molecule having a number of repeating monomer units and is a species of the term polymer. The term “polymer” means any polymerized product and includes oligomers, polymers and resins.

“One or more”, as used herein, relates to at least one and comprises 1, 2, 3, 4, 5, 6, 7, 8, 9 or more of the referenced species. Similarly, “at least one” means one or more, i.e., 1, 2, 3, 4, 5, 6, 7, 8, 9 or more. “At least one”, as used herein in relation to any component, refers to the number of chemically different molecules, i.e., to the number of different types of the referenced species, but not to the total number of molecules. For example, “at least one polyol” means that at least one type of molecule falling within the definition for a polyol is used but that also two or more different polyol types falling within this definition can be present but does not mean that only one type of said polyol is necessarily present. When a range of values is provided the range includes all values within the range.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

Unless explicitly indicated otherwise, all percentages that are cited in connection with the compositions described herein refer to weight percent (wt. %) with respect to final composition with all components, unless stated otherwise.

Radiation curable compositions generally comprise one or more polymers having (meth)acrylate functional groups; one or more diluents; one or more tack lessening additives; optionally one or more photoinitiators and optionally one or more additives. In preferred embodiments the radiation curable composition comprises a plurality of different polymers having (meth)acrylate functional groups; a plurality of different reactive diluents each having a different number of (meth)acrylate functional groups; one or more tack lessening additives; optionally one or more photoinitiators and optionally one or more additives.

### Polymers Having (Meth)Acrylate Functional Groups

In one embodiment the backbone of the (meth)acrylate polymer is formed from various monofunctional (meth)acrylate monomers, such as homopolymers of monofunctional C₁₋₁₀ alkyl (meth)acrylates and copolymers of monofunctional C₁₋₁₀ alkyl (meth)acrylates. Among the particularly useful monomers used include ethyl acrylate, methoxyethyl acrylate, n-butyl acrylate and homopolymers and copolymers thereof. As additional examples of useful monomers, there are included (meth)acrylic monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate), phenyl (meth)acrylate, tolyl (meth)acrylate, benzyl (meth)acrylate, carboxyethyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, gamma-(methacryloxoxypropyl) trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, 2-perfluorohexadecylethyl (meth)acrylate, etc.; styrenic monomers such as styrene, vinyltoluene, alpha-methylstyrene, chlorostyrene, styrenesulfonic acid and its salt; fluorine-containing vinyl monomers such as perfluoroethylene, perfluoropropylene, vinylidene fluoride, etc.; silicon-containing vinyl monomers such as vinyltrimethoxysilane, vinyltriethoxysilane, etc.; maleic anhydride, maleic acid, monoalkyl esters and dialkyl esters of maleic acid; fumaric acid and monoalkyl esters and dialkyl esters of fumaric acid; maleimide monomers such as maleimide, methylmaleimide, ethylmaleimide, propylmaleimide, butylmaleimide, hexylmaleimide, octylmaleimide, dodecyclmaleimide, stearylmaleimide phenylmaleimide, cyclohexylmaleimide, etc.; nitrile-containing vinyl monomers such as acrylonitrile, methacrylonitrile, etc.; amide-containing vinyl monomers such as acrylamide, methacrylamide, etc.; vinyl esters such as vinyl acetate, vinyl propionate, vinyl pivalate, vinyl benzoate, vinyl cinnamate, etc.; alkenes such as ethylene, propylene, etc.; conjugated dienes such as butadiene, isoprene, etc.; vinyl chloride, vinylidene chloride, allyl chloride and allyl alcohol. These monomers may be used singly or a plurality of them may be copolymerized.

In another embodiment the backbone of the (meth)acrylate oligomer may be formed from or include one or more polymeric segments or units. Such segments include one or more of urethane, styrene, polyolefin, isoprene, butadiene, polyisobutylene, acrylamide, nylon, (meth)acrylonitrile and/or substituted (meth)acrylonitrile. Useful (meth)acrylate functionalized urethanes include tetramethylene glycol urethane acrylate oligomer and a propylene glycol urethane acrylate oligomer. Other (meth)acrylate-functionalized urethanes are urethane (meth)acrylate polymers based on polyethers or polyesters, which are reacted with aromatic, aliphatic, or cycloaliphatic diisocyanates and capped with acrylates. Some useful examples include difunctional urethane acrylate oligomers, such as a polyester of hexanedioic acid and diethylene glycol, terminated with isophorone diisocyanate, capped with 2-hydroxyethyl acrylate; a polypropylene glycol terminated with tolyene-2,6-diisocyanate, capped with 2-hydroxyethylacrylate; a polyester of hexanedioic acid and diethylene glycol, terminated with 4,4′-methylenebis(cyclohexyl isocyanate), capped with 2-hydroxyethyl acrylate; a polyester of hexanedioic acid, 1,2-ethanediol, and 1,2 propanediol, terminated with tolylene-2,4-diisocyanate, capped with 2-hydroxyethyl acrylate; a polyester of hexanedioic acid, 1,2-ethanediol, and 1,2 propanediol, terminated with 4,4′-methylenebis(cyclohexyl isocyanate, capped with 2-hydroxyethyl acrylate; and a polytetramethylene glycol ether terminated with 4,4′-methylenebis(cyclohexylisocyanate), capped with 2-hydroxyethyl acrylate. Still other (meth)acrylate-functionalized urethanes are monofunctional urethane acrylate oligomers, such as a polypropylene terminated with 4,4′-methylenebis(cyclohexylisocyanate), capped with 2-hydroxyethyl acrylate and 1-dodosanol. (Meth)acrylate-functionalized urethanes also include difunctional urethane methacrylate oligomers such as a polytetramethylene glycol ether terminated with tolulene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; and a polypropylene glycol terminated with tolylene-2,4-diisocyanate, capped with 2-hydroxyethyl methacrylate.

In one embodiment the (meth)acrylate oligomer or polymer has a polyisobutylene backbone and is represented by a general formula (1):

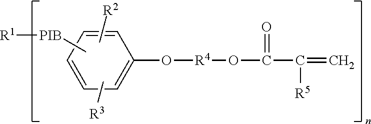

wherein R¹ represents a monovalent or polyvalent aromatic hydrocarbon group or a monovalent or polyvalent aliphatic hydrocarbon group, preferably a divalent phenylene group, PIB represents the polyisobutylene backbone containing a plurality of repeating [CH₂C(CH₃)₂]— units, R² and R³ each independently represent a hydrogen atom or a monovalent hydrocarbon group having 1 to 20 carbon atoms, R⁴ represents a divalent hydrocarbon group having 2 to 6, preferably 3 or 4, carbon atoms and optionally containing an oxygen atom, R⁵ represents a hydrogen atom, a methyl group, an ethyl group, or a propyl group, and n is any integer of 1 to 6, preferably 2 or 3.

The number average molecular weight (Mn) of the (meth)acrylate oligomer maybe 1000 to 100,000, more desirably 2000 to 50,000.

The (meth)acrylate oligomer or polymer can be prepared using standard techniques known in the art, or obtained from suitable commercial sources. Preparation techniques include controlled radical polymerization processes, including Single Electron Transfer Living Radical Polymerization (SET-LRP), by stable free radical polymerization (SFRP) such as reversible deactivation by coupling, or by degenerative transfer (DT). Once the polymerization is complete, the method may include further reacting the resultant polymer to form functional end groups onto the polymer. Forming functional ends on the polymer may be done, for example, by performing either an end-capping reaction or a substitution reaction.

A combination of 2 or more acrylate functional oligomers and/or acrylate functional polymers can be used to tune the uncured and cured properties of the composition.

### Diluent

The curable composition can optionally include at least one diluent and/or reactive diluent. Useful reactive diluents can comprise compounds having one or more (meth)acrylate functional groups. Illustrative examples of useful (meth)acrylates, include alkyl (meth)acrylates, cycloalkyl (meth)acrylates, alkenyl (meth)acrylates, heterocycloalkyl (meth)acrylates, heteroalkyl methacrylates, alkoxy polyether mono(meth)acrylates, and amide-containing vinyl monomers such as (meth)acrylamide and di(meth)acrylamide.

The alkyl group on the (meth)acrylate desirably may be a substituted or unsubstituted alkyl group having 1 to 20 carbon atoms, desirably 1 to 10 carbon atoms, optionally having at least one substituent selected from an alkyl group having 1 to 10 carbon atoms, substituted or unsubstituted cycloalkyl group having 1 to 20 carbon atoms, desirably 1 to 10 carbon atoms, substituted or unsubstituted bicyclo or tricycloalkyl group having 1 to 20 carbon atoms, desirably 1 to 15 carbon atoms, an alkoxy group having 1 to 10 carbon atoms, an aryloxy group having 6 to 10 carbon atoms.

The alkenyl group on the (meth)acrylate desirably may be a substituted or unsubstituted alkenyl group having 2 to 20 carbon atoms, desirably 2 to 10 carbon atoms, optionally having at least one substituent selected from an alkyl group having 1 to 10 carbon atoms, an alkoxy group having 1 to 10 carbon atoms, an aryloxy group having 6 to 10 carbon atoms, an epoxy group having 2 to 10 carbon atoms, hydroxyl and the like.

The heterocyclo group on the (meth)acrylate desirably may be a substituted or unsubstituted heterocyclo group having 2 to 20 carbon atoms, desirably 2 to 10 carbon atoms, containing at least one hetero atom selected from N and O, and optionally having at least one substituent selected from an alkyl group having 1 to 10 carbon atoms, an alkoxy group having 1 to 10 carbon atoms, an aryloxy group having 6 to 10 carbon atoms, or an epoxy group having 2 to 10 carbon atoms.

The alkoxy polyether mono(meth)acrylates can be substituted with an alkoxy group having 1 to 10 carbons and the polyether can have 1 to 10 repeat units.

Some exemplary (meth)acrylate monomers include, but are not limited to, meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, isobornyl (meth)acrylate; tetrahydrofurfuryl acrylate; benzyl (meth)acrylate, carboxyethyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl) trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate. In an aspect of the present invention, the (meth)acrylate monomer is polyethylene glycol diacrylate, such as SR 259 (polyethylene glycol (200) diacrylate from Sartomer). Some useful multifunctional (meth)acrylates include, for example, polyethylene glycol di (meth)acrylates, desirably triethyleneglycol di(meth)acrylate, hydroxypropyl (meth)acrylate, bisphenol-A di(meth)acrylates, such as ethoxylated bisphenol-A (meth)acrylate (“EBIPA” or “EBIPMA”), and tetrahydrofuran (meth)acrylates and di(meth)acrylates, citronellyl acrylate and citronellyl methacrylate, hexanediol di(meth)acrylate (“HDDA” or “HDDMA”), trimethylol propane tri(meth)acrylate, tetrahydrodicyclopentadienyl (meth)acrylate, ethoxylated trimethylol propane triacrylate (“ETTA”), triethylene glycol diacrylate, pentaerythritol tetraacrylate, and triethylene glycol dimethacrylate (“TRIEGMA”).

### Tack Lessening Component

The tack lessening component reduces the surface stickiness or tackiness of a cured or even partially cured radiation curable composition. Typical tack lessening agents can comprise polysiloxane moieties. However, polysiloxane homopolymers are poorly soluble or dispersible in radiation curable compositions. It is preferable for the tack lessening component to be free or substantially free of polysiloxane homopolymers. It is preferable for the tack lessening component to comprise a copolymer of polysiloxane and other polymeric segments, such as polyester and/or polyether, in the molecule backbone. The tack lessening component can comprise one or preferably more acrylate functional groups on the molecule. The acrylate functional groups can be pendant or terminal on the molecule. In other embodiments the tack lessening component can be free or substantially free of acrylate functional groups on the molecule. The tack lessening component can be used as a mixture with a (meth)acrylate diluent for ease of handling.

One useful tack lessening component is BYK-3505 available from BYK-Chemie GmbH in Germany. BYK-3505 is described as a multi-acrylic functional, modified polydimethylsiloxane macromer having an AB molecular architecture that has been functionalized at only one end of the molecule. The AB structure is combinations or polyether/polyester and a high content of polysiloxane. BYK-3505 is supplied in a diacrylate monomer (TPGDA). Another useful tack lessening agent is BYK-3510 also available from BYK-Chemie GmbH. BYK-3510 is described as a polyether modified polydimethylsiloxane with no reactive moieties. BYK-3510 is supplied in a diacrylate monomer (TPGDA). Naturally, a combination of different tack lessening components can be used in the radiation curable composition.

### Photoinitiator

The curable composition includes at least one photoinitiator to help initiate and induce curing when the composition is exposed to radiation. Typical photoinitiators will induce curing when the composition is exposed to ultraviolet (UV) or visible wavelength radiation. Naturally, photoinitiators should be chosen to be active at the UV wavelengths used for curing.

Useful polymeric thioxanthone derivative photoinitiators include Genopol TX available from Rahn; OMNIPOL TX (formula below) available from IGM; and SPEEDCURE 7010-L available from Lambson. Other photoinitiators are described in U.S. Pat. Nos. 9,278,949, 8,883,873, 7,354,957 and International Patent Publication Number WO2009060235, the contents of each of which is included by reference herein.

Other useful photoinitiators that respond to radiation to initiate and induce curing of the curable composition include, but are not limited to, low-wavelength photoinitiators such as hydroxycyclohexyl phenyl ketone available as Tinocure 184; aromatic tertiary amines such as ethyl-4-dimethylaminobenzoate Genocure EPD, Ethyl-4-dimethylaminiobenzoate, polymeric aminobenzoate derivatives such as Genopol AB-2, Omnipol ASA, amine acrylate such as Genomer 5142, 5161, 5271, 6275, Photomer 4250, 4771, 4775, 4780, 4967, 5006 and phosphine oxide photoinitiators such as trimethylbenzoyl diphenyl phosphine oxide. One useful co-photoinitiator is Genopol AB-2 available from Rahn.

One photoinitator or a combination of different photoinitiators can be used. Photoinitiators may be employed in amounts of about 0.1% to about 10% by weight of the total composition. More desirably, the photoinitiator is present in amounts of about 0.5% to about 5% by weight of the total composition.

### Additives

The curable composition can optionally include one or more additives. Optional additives include, for example, stabilizer, inhibitor, oxygen scavenging agent, dye, colorant, pigment, filler, adhesion promoter, plasticizer, toughening agent, reinforcing agent, fluorescing agent, wetting agent, antioxidant, rheology modifier, thermoplastic polymer, tackifier and combinations thereof. The curable composition can also be free of any or all of these additives.

The curable composition can optionally include at least one type of filler. Suitable fillers can be organic or inorganic. Some useful fillers include, for example, organic fillers such as polymer powders, fibers and microspheres; lithopone; zirconium silicate; diatomaceous earth; clay; hydroxides such as hydroxides of calcium, aluminum, magnesium, iron and the like; carbonates such as carbonates of sodium, potassium, calcium, magnesium and the like; metal oxides such as metal oxides of calcium, zinc, magnesium, chromium, zirconium, aluminum, titanium, iron and silicon; silica; fumed silica, which may be untreated, such as AEROSIL R 8200 available from Degussa, or treated with an adjuvant, for example HDK2000 available from Wacker-Chemie. Combinations of different fillers may also be useful. Fillers may be employed in amounts of about 5.0% to about 50% by weight of the total composition. More desirably, filler is present in amounts of 15.0% to about 40% by weight of the total composition.

In some embodiments the radiation curable compositions have formulations falling in one or more of the following ranges.

| | | preferred range |
|---|---|---|
| | broad range (wt. %) | (wt. %) |
| oligomers or polymers having | 5-75 | 10-60 |
| (meth)acrylate functional groups | | |
| diluent | 0-50 | 1-40 |
| tack lessening component | 0.1-5.0 | 0.5-2.0 |
| photoinitiator | 0-5 | 0-3 |
| additive | 0-10 | 0-5 |

In some embodiments the radiation curable compositions have formulations falling in one or more of the following ranges.

| | broad range | preferred range |
|---|---|---|
| | (wt. %) | (wt. %) |
| first polymer having (meth)acrylate | 10-60 | 20-40 |
| functional groups and a viscosity | | |
| >20,000 cP at 60° C. | | |
| second polymer having (meth)acrylate | 10-60 | 10-40 |
| functional groups and a viscosity | | |
| <20,000 cP at 60° C. | | |
| third polymer having (meth)acrylate | 0-30 | 0-20 |
| functional groups and a viscosity | | |
| <6,000 cP at 60° C. | | |
| reactive diluent having one acrylate | 0-45 | 20-40 |
| functional group | | |
| reactive diluent having two acrylate | 0-20 | 0-10 |
| functional groups | | |
| reactive diluent having three | 0-20 | 1-10 |
| functional groups | | |
| reactive diluent having four or | 0-20 | 1-10 |
| more functional groups | | |
| tack lessening component | 0.1-5.0 | 0.5-2.0 |
| photoinitiator | 0-5 | 0-3 |
| additive | 0-10 | 0-5 |

In some embodiments the polymers can be in a ratio of 3.5-4.5 parts first polymer having (meth)acrylate functional groups and a viscosity >20,000 cP at 60° C. to 1.5-2.5 parts second polymer having (meth)acrylate functional groups and a viscosity <20,000 cP at 60° C. to 0.5 to 1.5 parts third polymer having (meth)acrylate functional groups and a viscosity <6,000 cP at 60° C. The parts are parts by weight of the total polymer content in the composition.

In some embodiments the reactive diluents can be in a ratio of 4.5-7.5 parts singly acrylate functional reactive diluent to 0.5-1.5 parts tri acrylate functional reactive diluent to 0.5-1.5 parts tetra acrylate functional reactive diluent. The parts are parts by weight of the total reactive diluent content in the composition.

In some embodiments the reactive diluents can be in a ratio of 1-2 parts isobornyl acrylate to 2.5 to 3.5 parts N,N-dimethylacrylamide to 1 to 2 parts tetrahydrofurfuryl acrylate. The parts are parts by weight of the total reactive diluent content in the composition.

In some embodiments the reactive diluents can be in a ratio of 1-2 parts isobornyl acrylate to 2.5 to 3.5 parts N,N-dimethylacrylamide to 1 to 2 parts tetrahydrofurfuryl acrylate to 0.5-1.5 parts tri acrylate functional reactive diluent to 0.5-1.5 parts tetra acrylate functional reactive diluent. The parts are parts by weight of the total reactive diluent content in the composition.

In the ratios above the combined balanced addition of a small amount of multi-functional diluents (tri- and tetra) and the tack-lessening components (TLC), relative to mono-functional and difunctional resins, allows for faster gel formation at the curing surface, especially in very short light exposure situations. Thereby, with this combination, faster gel formation at the curing surface with very short light exposure conditions, provides for improved surface tack properties without compromising the desired physical properties of adhesive strength or flexibility.

In some embodiments the uncured composition will have a viscosity in the range of about 100 to 25,000 cP at 25° C. . . . In some embodiments where flow of the composition is desired a viscosity of about 1,000 to 2,200 cP at 25° C. A viscosity in this range allows more precision in the application of small amounts of adhesive to a part.

In some embodiments the composition after very short exposure to actinic radiation will have a tack rating of 2 or less and more preferably 0-1. Very short exposure refers to exposure of the composition to 400 mW/cm² of actinic radiation in the ultraviolet or 405 nm wavelength for a time of less than 5 seconds. In preferred embodiments the exposure time is less than 2 seconds, or less than 1 second, or less than 0.5 seconds, or less than 0.2 seconds or less than 0.1 seconds. This irradiance is less than conventionally used and the exposure time is an order of magnitude less than conventionally used. The ability to provide a tack free surface after these irradiation schedules is surprising and desirable.

In some embodiment the cured composition will have an elongation of about 100% or more, preferably about 150% or more, more preferably about 200% or more. An elongation in this range provides the cured adhesive with flexibility, allowing the cured adhesive to bend with bonded flexible components without breaking the bond. Flexible parts or components are typically those that can be readily flexed or bent or folded by a user by hand and without the use of tools. Some flexible substrates include polymers such as acrylic and polyurethane; thin metals, for example foils and wire; and rubber. In some embodiment the cured composition will have an elongation of less than about 150%. These cured compositions will be relatively rigid which is more suited to bonding inflexible substrates such as ceramic; and thick, rigid polymer articles or thick, rigid metal articles.

In some embodiments the cured adhesive will have a strength of about 500 to 1,600 psi. In these embodiments the low bond strength desirably allows the bond to fail within the adhesive or at the part surface to adhesive interface, leaving the part surface substantially intact.

Typically, an article is comprised of a plurality of parts, some of which will be adhesively bonded together. Each part can independently be constructed of one material or a plurality of materials arranged in a desired fashion. The parts to be bonded have a bonding surface. An amount of uncured composition is disposed at discrete points on some portion of the bonding surface or all of a first part bonding surface. A second part is positioned so that the second part bonding surface is adjacent the first part bonding surface and in contact with the disposed composition. The composition disposed between the first and second parts is cured by exposure to radiation so that cured reaction products of the disposed composition adhesively secure the first part to the second part.

In some embodiments the cured composition bonds two or more flexible parts in an article. In other embodiments the cured adhesive bond strength is low enough to allow the bonded surfaces to be separated without substantially damaging the bonding surfaces. The separation can be done by a user manually with or without use of tools.

The following examples are included for purposes of illustration so that the disclosure may be more readily understood and are in no way intended to limit the scope of the disclosure unless otherwise specifically indicated.

### Viscosity Testing

Uncured samples were tested using a Physica MCR301 viscosimeter having a 50 mm cone and a shear rate of 50 s⁻¹. Tested at 25° C.

### Tack Test Sample Preparation

Clean glass slides having a thickness of about 0.038 inches were used. A rectangular polymeric spacer having an outside dimension approximating the glass slide, a rectangular internal space and a height of abought 0.038 was placed on the top surface of one slide. Six drops of a test composition was placed within the open spacer center. Another glass slide was used to draw the sample to the height of the spacer. Material thickness was checked after curing.

### Tack Test Sample Cure

The samples on microscope slides were cured using a Loctite LED 405 nm flood system. Sample curing time was either 5 seconds or 30 seconds. Exposure at 5 and 30 seconds only differentiated any potential for the effects of longer cure on surface tack. The curing light intensity is shown in the table below. Intensity was measured using a UV V radiometer.

| | Radiation | radiation intensity |
|---|---|---|
| Curing radiation | wavelength peak | mW/cm² |
| LED 405 nm | 405 nm | 400 |

### Cured Sample Tack Testing

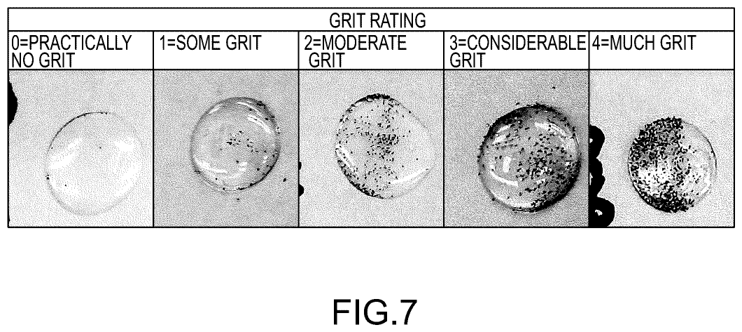

80 grit silicon carbide powder is sprinkled over the cured surface of a sample on a microscope slide until the entire sample surface is covered. A 1 inch (25.4 mm) wide paint brush is provided (Loew-Cornell 257 or equivalent). Using only the weight of the paintbrush, remove the loose silicon carbide grit from the sample surface by brushing four times over the length of the cured surface and another four times over the width of the cured surface. Evaluate the brushed sample using the following scale. Note that silicon carbide grit present only at some or all of the extreme edges of the sample should be considered tack free. See FIG. 7 for a comparison.
0 practically no grit, little tack on surface. This is the least tacky result.
1 some grit
2 moderate grit
3 considerable grit
4 much grit, full surface covered, surface very tacky. This is the most tacky result.

### Elongation Testing

Uncured composition was placed on a glass slide and cured as previously described to prepare a 150 mm by 6 mm by 1 mm thick sample. Using ASTM method D882-09 (Jan. 1, 2009), the sample was placed in a tensile test apparatus and the elongation when the sample broke was noted.

### Block Shear Strength Testing

The following is derived from ASTM D4501-01 (Mar. 10, 2001). Uncured composition was placed on a large face of a 76.2 mm by 76.2 mm by 12.7 mm thick polycarbonate specimen so that a 12.7 mm (0.5 in) wide band adjacent an edge of the first specimen is completely covered. A second specimen was placed on the applied composition so that the large face of the second specimen is partially overlapped over the adhesive and large face of the first block and there is a 12.7 mm (0.5 in) wide bond area between the blocks. The specimens and uncured composition were exposed to 405 nm light 1,000 mW/cm² for a desired to cure. Generally following ASTM D882-09 (Jan. 1, 2009), the cured sample was placed in a tensile test apparatus and the force required to separate the bonded parts was noted.

### Example 1

Two base formulations differing in viscosity were prepared as shown in the following table. Components were added and mixed to homogeneity. Formulation A had a subjectively lower viscosity than formulation B. Neither formulation included a tack lessening component. All amounts are in parts by weight of the composition.

| material | A | B |
|---|---|---|
| diluent¹ | 70.95 | 65.95 |
| optical brightener² | 0.05 | 0.05 |
| photoinitiator³ | 4.00 | 4.00 |
| adhesion promoter⁴ | 1.00 | 1.00 |
| oligomer⁵ | 23.00 | 28.00 |
| tack lessening component | 0 | 0 |

¹isobornyl acrylate
²Tinopal OB CO No. 5 available from BASF.
³Omnirad TPO-L available from IGM Resins USA Inc.
⁴gamma-glycidoxypropyftrimethoxysilane (GLYMO g-GPTMS) available as Silquest A-187 from Momentive Performance Materials.
⁵Epion EP400V available from Kaneka Corporation.

Base formulation A was used to prepare radiation curable compositions including a tack lessening component as shown in the following table. All amounts are in parts by weight.

| material | A | 1 | 2 | 3 | 4 |
|---|---|---|---|---|---|
| A formulation | 100 | 99.0 | 99.0 | 99.0 | 99.0 |
| Tack lessening | 0 | 1.0 | 0 | 0 | 0 |
| component 1¹ | | | | | |
| Tack lessening | 0 | 0 | 1.0 | 0 | 0.5 |
| component 2² | | | | | |
| Functional | 0 | 0 | 0 | 1.0 | 0.5 |
| diluent³ | | | | | |

¹BYK UV-3505 available from BYK-Chemie GmbH
²BYK-UV-3510 available from BYK-Chemie GmbH
³tripropylene glycol diacrylate (TPGDA) available from IGM Resins USA Inc. as Photomer 4061.

| material | B | 5 | 6 | 7 | 8 |
|---|---|---|---|---|---|
| B formulation | 100 | 99.0 | 99.0 | 99.0 | 99.0 |
| Tack lessening | 0 | 1.0 | 0 | 0 | 0 |
| component 1¹ | | | | | |
| Tack lessening | 0 | 0 | 1.0 | 0 | 0.5 |
| component 2² | | | | | |
| diluent³ | 0 | 0 | 0 | 1.0 | 0.5 |

¹BYK UV-3505 available from BYK-Chemie GmbH
²BY-UV-3510 available from BYK-Chemie GmbH
³tripropylene glycol diacrylate (TPGDA) available from IGM Resins USA Inc. as Photomer 4061.

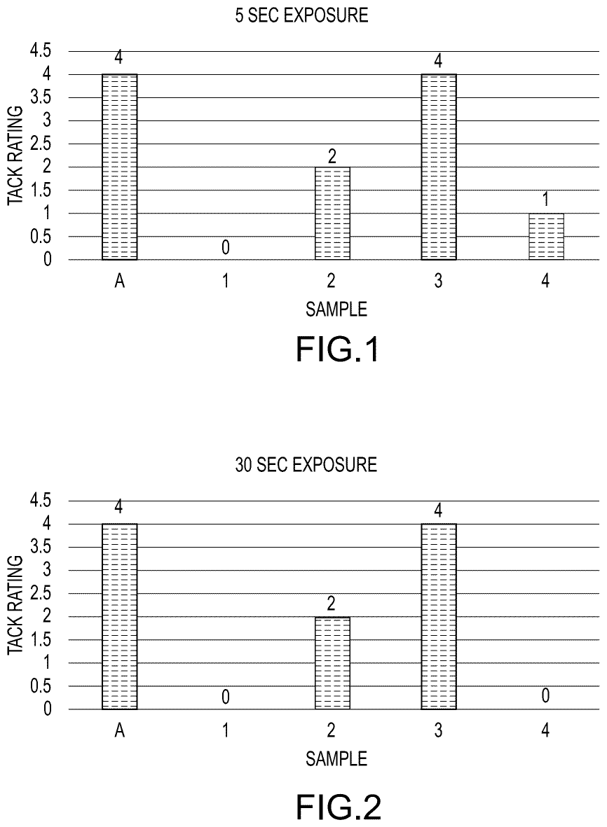

Multiple samples of each composition were placed on a microscope slide. Three samples of each composition were cured with (exposed for) either 5 or 30 seconds of light and subsequently tested for tack free properties using the previously described cured sample tack test; the results were averaged with the averaged values being rounded. Results are shown in the Tables below and FIGS. 1 to 4. In each of the Tables; M. Film Thickness is the measured thickness of the sample in inches; C. Film Thickness is the film thickness in mm calculated from the measured film thickness; and EXP. Time is the sample exposure time to radiation in seconds. 4 is a worst result and 0 is a best result.

| | M. Film | C. Film | Exp. | |
|---|---|---|---|---|
| Sample | Thick (in) | Thick (mm) | Time (sec) | Rating |
| A | 0.018 | 0.46 | 5 | 4 |
| A | 0.021 | 0.53 | 5 | 4 |
| A | 0.021 | 0.53 | 5 | 4 |
| average | 0.02 | 0.51 | | 4 |
| 1 | 0.016 | 0.41 | 5 | 1 |
| 1 | 0.024 | 0.61 | 5 | 0 |
| 1 | 0.026 | 0.66 | 5 | 0 |
| average | 0.02 | 0.51 | | 0 |
| 2 | 0.015 | 0.38 | 5 | 2 |
| 2 | 0.022 | 0.56 | 5 | 2 |
| 2 | 0.016 | 0.41 | 5 | 2 |
| average | 0.018 | 0.45 | | 2 |
| 3 | 0.022 | 0.56 | 5 | 4 |
| 3 | 0.018 | 0.46 | 5 | 4 |
| 3 | 0.021 | 0.53 | 5 | 4 |
| average | 0.020 | 0.52 | | 4 |
| 4 | 0.024 | 0.61 | 5 | 0 |
| 4 | 0.016 | 0.41 | 5 | 1 |
| 4 | 0.019 | 0.48 | 5 | 1 |
| average | 0.020 | 0.50 | | 1 |

Results for the above Table are shown graphically in FIG. 1.

| | Film | Film | Exp. | |
|---|---|---|---|---|
| Sample | Thick (in) | Thick (mm) | Time (sec) | Rating |
| A | 0.015 | 0.38 | 30 | 4 |
| A | 0.018 | 0.46 | 30 | 4 |
| A | 0.02 | 0.51 | 30 | 4 |
| average | 0.02 | 0.45 | | 4 |
| 1 | 0.013 | 0.33 | 30 | 1 |
| 1 | 0.02 | 0.51 | 30 | 0 |
| 1 | 0.022 | 0.56 | 30 | 0 |
| average | 0.02 | 0.47 | | 0 |
| 2 | 0.016 | 0.41 | 30 | 2 |
| 2 | 0.016 | 0.41 | 30 | 2 |
| 2 | 0.019 | 0.48 | 30 | 1 |
| average | 0.02 | 0.43 | | 2 |
| 3 | 0.017 | 0.43 | 30 | 4 |
| 3 | 0.02 | 0.51 | 30 | 4 |
| 3 | 0.019 | 0.48 | 30 | 4 |
| average | 0.02 | 0.47 | | 4 |
| 4 | 0.024 | 0.61 | 30 | 1 |
| 4 | 0.02 | 0.51 | 30 | 0 |
| 4 | 0.024 | 0.61 | 30 | 0 |
| average | 0.02 | 0.58 | | 0 |

Results for the above Table are shown graphically in FIG. 2.

| | Film | Film | Exp. | |
|---|---|---|---|---|
| Sample | Thick (in) | Thick (mm) | Time (sec) | Rating |
| B | 0.024 | 0.61 | 5 | 4 |
| B | 0.025 | 0.64 | 5 | 4 |
| B | 0.024 | 0.61 | 5 | 4 |
| average | 0.02 | 0.61 | | 4 |
| 5 | 0.026 | 0.66 | 5 | 0 |
| 5 | 0.027 | 0.69 | 5 | 1 |
| 5 | 0.02 | 0.51 | 5 | 1 |
| average | 0.02 | 0.61 | | 1 |
| 6 | 0.025 | 0.64 | 5 | 2 |
| 6 | 0.021 | 0.53 | 5 | 2 |
| 6 | 0.025 | 0.64 | 5 | 2 |
| average | 0.02 | 0.60 | | 2 |
| 7 | 0.027 | 0.69 | 5 | 2 |
| 7 | 0.021 | 0.53 | 5 | 3 |
| 7 | 0.027 | 0.69 | 5 | 3 |
| average | 0.02 | 0.63 | | 3 |
| 8 | 0.014 | 0.36 | 5 | 1 |
| 8 | 0.024 | 0.61 | 5 | 1 |
| 8 | 0.019 | 0.48 | 5 | 0 |
| average | 0.02 | 0.48 | | 1 |

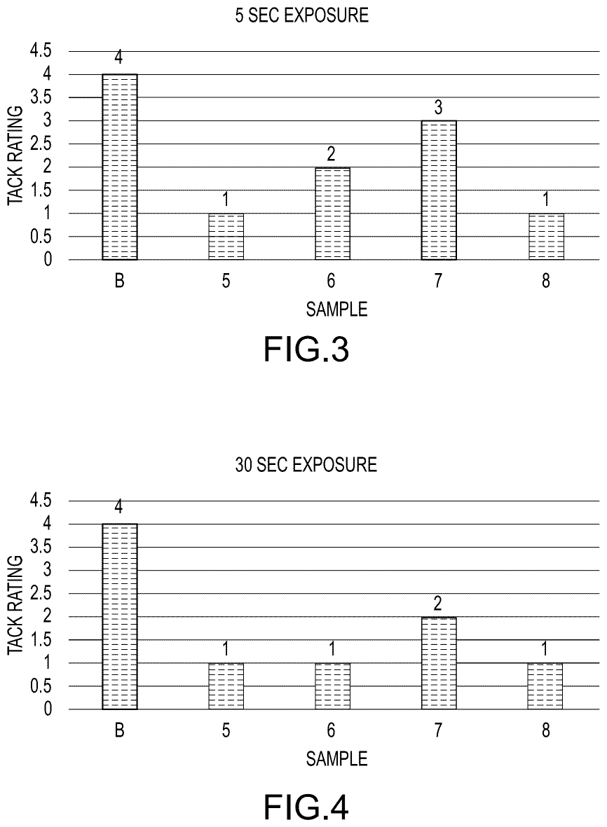

Results for the above Table are shown graphically in FIG. 3.

| | Film | Film | Exp. | |
|---|---|---|---|---|
| Sample | Thick (in) | Thick (mm) | Time (sec) | Rating |
| B | 0.02 | 0.51 | 30 | 4 |
| B | 0.02 | 0.51 | 30 | 4 |
| B | 0.023 | 0.58 | 30 | 4 |
| average | 0.02 | 0.53 | | 4 |
| 5 | 0.022 | 0.56 | 30 | 1 |
| 5 | 0.027 | 0.69 | 30 | 0 |
| 5 | 0.021 | 0.53 | 30 | 1 |
| average | 0.02 | 0.59 | | 1 |
| 6 | 0.015 | 0.38 | 30 | 2 |
| 6 | 0.015 | 0.38 | 30 | 1 |
| 6 | 0.024 | 0.61 | 30 | 1 |
| average | 0.02 | 0.46 | | 1 |
| 7 | 0.025 | 0.64 | 30 | 2 |
| 7 | 0.022 | 0.56 | 30 | 1 |
| 7 | 0.019 | 0.48 | 30 | 2 |
| average | 0.02 | 0.56 | | 2 |
| 8 | 0.021 | 0.53 | 30 | 1 |
| 8 | 0.026 | 0.66 | 30 | 0 |
| 8 | 0.024 | 0.61 | 30 | 1 |
| average | 0.02 | 0.60 | | 1 |

Results for the above Table are shown graphically in FIG. 4.

In each of the above Tables test Formulation A provided the worst result of 4 (most tack). Adding tack lessening component 1 changed the formulation from the most tack to the least tack. Adding TPGDA did not change the tack result from the highest tack of formulation A. Adding TPGDA and tack lessening agent 2 decreased the tack of formulation A substantially (1 very low tack).

### Example 2

Different tack lessening components were added to commercially available radiation curable compositions C, D, E and F. The sample formulations are shown in the table below. All parts are by weight.

| material | 9 | 10 | 11 | 12 | 13 | 14 | 15 | 16 |
|---|---|---|---|---|---|---|---|---|
| C¹ | 99.0 | 99.0 | 0 | 0 | 0 | 0 | 0 | 0 |
| D² | 0 | 0 | 99.0 | 99.0 | 0 | 0 | 0 | 0 |
| E³ | 0 | 0 | 0 | 0 | 99.0 | 99.0 | 0 | 0 |
| F⁴ | 0 | 0 | 0 | 0 | 0 | 0 | 99.0 | 99.0 |
| TLC1⁵ | 1 | 0 | 1 | 0 | 1 | 0 | 1 | 0 |
| TLC2⁶ | 0 | 0.5 | 0 | 0.5 | 0 | 0.5 | 0 | 0.5 |
| diluent⁷ | 0 | 0.5 | 0 | 0.5 | 0 | 0.5 | 0 | 0.5 |

¹Loctite 3341, a radiation curable composition available from Henkel Corporation, US.
²Loctite 3921, a radiation curable composition available from Henkel Corporation, US.
³Loctite 3951, a radiation curable composition available from Henkel Corporation, US.
⁴Loctite 3961, a radiation curable composition available from Henkel Corporation, US.
⁵tack lessening component 1; BYK UV-3505
⁶tack lessening component 2; BYK UV-3510
⁷tripropylene glycol diacrylate (TPGDA) available from IGM Resins USA Inc. as Photomer 4061.

Cured samples were prepared as disclosed above and tested using the previously described cured sample tack test. Results are shown in the Tables below. In each of the Tables; M. Film Thickness is the measured thickness of the sample in inches; C. Film Thickness is the film thickness in mm calculated from the measured film thickness; and EXP. Time is the sample exposure time to radiation in seconds. 4 is a worst result and 0 is a best result.

| | M. Film | C. Film | Exp. | |
|---|---|---|---|---|
| Sample | Thick (in) | Thick (mm) | Time (sec) | Rating |
| C | 0.062 | 1.57 | 5 | 2 |
| C | 0.061 | 1.55 | 5 | 2 |
| C | 0.064 | 1.63 | 5 | 2 |
| average | 0.061 | 1.55 | | 2 |
| 9 | 0.064 | 1.63 | 5 | 1 |
| 9 | 0.062 | 1.57 | 5 | 1.5 |
| 9 | 0.065 | 1.65 | 5 | 1 |
| average | 0.062 | 1.58 | | 1 |
| 10 | 0.063 | 1.60 | 5 | 1 |
| 10 | 0.063 | 1.60 | 5 | 1 |
| 10 | 0.062 | 1.57 | 5 | 1 |
| average | 0.063 | 1.59 | | 1 |

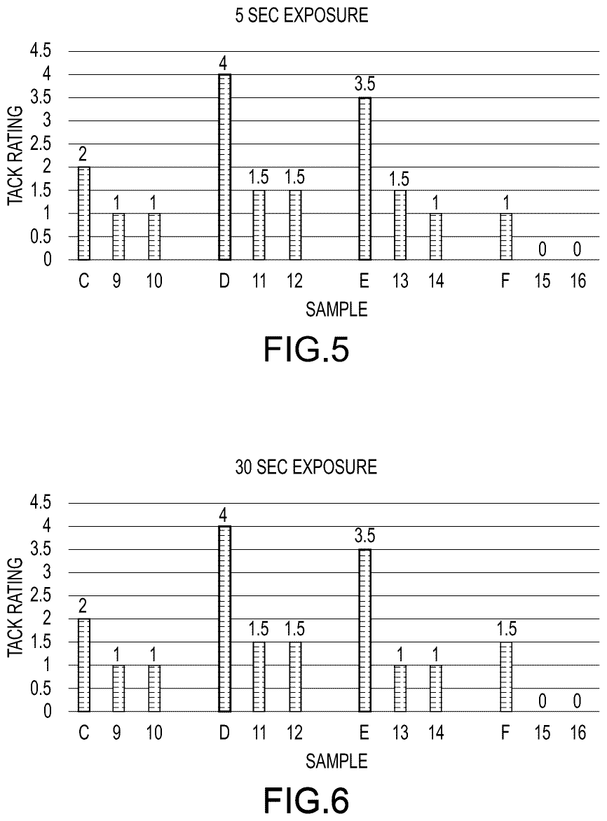

Results for the above Table are shown graphically in FIG. 5.

| | M. Film | C. Film | Exp. | |
|---|---|---|---|---|
| Sample | Thick (in) | Thick (mm) | Time (sec) | Rating |
| D | 0.06 | 1.52 | 5 | 4 |
| D | 0.055 | 1.40 | 5 | 4 |
| D | 0.056 | 1.42 | 5 | 4 |
| average | 0.057 | 1.45 | | 4 |
| 11 | 0.054 | 1.37 | 5 | 1.5 |
| 11 | 0.055 | 1.40 | 5 | 2 |
| 11 | 0.055 | 1.40 | 5 | 1.5 |
| average | 0.055 | 1.39 | | 1.5 |
| 12 | 0.06 | 1.52 | 5 | 1.5 |
| 12 | 0.066 | 1.68 | 5 | 1 |
| 12 | 0.056 | 1.42 | 5 | 1.5 |
| average | 0.06 | 1.54 | | 1.5 |

Results for the above Table are shown graphically in FIG. 5.

| | M. Film | C. Film | Exp. | |
|---|---|---|---|---|
| Sample | Thick (in) | Thick (mm) | Time (sec) | Rating |
| E | 0.065 | 1.65 | 5 | 3.5 |
| E | 0.064 | 1.63 | 5 | 3.5 |
| E | 0.068 | 1.73 | 5 | 3.5 |
| average | 0.07 | 1.67 | | 3.5 |
| 13 | 0.058 | 1.47 | 5 | 1.5 |
| 13 | 0.058 | 1.47 | 5 | 1 |
| 13 | 0.057 | 1.45 | 5 | 1.5 |
| average | 0.06 | 1.46 | | 1.5 |
| 14 | 0.058 | 1.47 | 5 | 1 |
| 14 | 0.058 | 1.47 | 5 | 1 |
| 14 | 0.059 | 1.50 | 5 | 1.5 |
| average | 0.06 | 1.48 | | 1 |

Results for the above Table are shown graphically in FIG. 5.

| | M. Film | C. Film | Exp. | |
|---|---|---|---|---|
| Sample | Thick (in) | Thick (mm) | Time (sec) | Rating |
| F | 0.064 | 1.63 | 5 | 1 |
| F | 0.056 | 1.42 | 5 | 1.5 |
| F | 0.062 | 1.57 | 5 | 1 |
| average | 0.06 | 1.54 | | 1 |
| 15 | 0.058 | 1.47 | 5 | 0.25 |
| 15 | 0.058 | 1.47 | 5 | 0.25 |
| 15 | 0.057 | 1.45 | 5 | 0.25 |
| average | 0.06 | 1.46 | | 0 |
| 16 | 0.056 | 1.42 | 5 | 0.25 |
| 16 | 0.059 | 1.50 | 5 | 0.25 |
| 16 | 0.055 | 1.40 | 5 | 0.25 |
| average | 0.06 | 1.44 | | 0 |

Results for the above Table are shown graphically in FIG. 5.

| | M. Film | C. Film | Exp. | |
|---|---|---|---|---|
| Sample | Thick (in) | Thick (mm) | Time (sec) | Rating |
| C | 0.066 | 1.68 | 30 | 2 |
| C | 0.064 | 1.63 | 30 | 2 |
| C | 0.063 | 1.60 | 30 | 2 |
| average | 0.06 | 1.53 | | 2 |
| 9 | 0.061 | 1.55 | 30 | 1 |
| 9 | 0.06 | 1.52 | 30 | 1.5 |
| 9 | 0.062 | 1.57 | 30 | 1 |
| average | 0.06 | 1.54 | | 1 |
| 10 | 0.06 | 1.52 | 30 | 1 |
| 10 | 0.061 | 1.55 | 30 | 1 |
| 10 | 0.064 | 1.63 | 30 | 0.5 |
| average | 0.06 | 1.57 | | 1 |

Results for the above Table are shown graphically in FIG. 6.

| | M. Film | C. Film | Exp. | |
|---|---|---|---|---|
| Sample | Thick (in) | Thick (mm) | Time (sec) | Rating |
| D | 0.056 | 1.42 | 30 | 4 |
| D | 0.058 | 1.47 | 30 | 4 |
| D | 0.056 | 1.42 | 30 | 4 |
| average | 0.06 | 1.44 | | 4 |
| 11 | 0.05 | 1.27 | 30 | 1.5 |
| 11 | 0.057 | 1.45 | 30 | 1 |
| 11 | 0.058 | 1.47 | 30 | 2 |
| average | 0.06 | 1.40 | | 1.5 |
| 12 | 0.059 | 1.50 | 30 | 1.5 |
| 12 | 0.064 | 1.63 | 30 | 1 |
| 12 | 0.056 | 1.42 | 30 | 1.5 |
| average | 0.06 | 1.51 | | 1.5 |

Results for the above Table are shown graphically in FIG. 6.

| | M. Film | C. Film | Exp. | |
|---|---|---|---|---|
| Sample | Thick (in) | Thick (mm) | Time (sec) | Rating |
| E | 0.059 | 1.50 | 30 | 3.5 |
| E | 0.059 | 1.50 | 30 | 3.5 |
| E | 0.06 | 1.52 | 30 | 4 |
| average | 0.06 | 1.51 | | 3.5 |
| 13 | 0.059 | 1.50 | 30 | 1 |
| 13 | 0.056 | 1.42 | 30 | 1.5 |
| 13 | 0.055 | 1.40 | 30 | 1.5 |
| average | 0.60 | 1.44 | | 1 |
| 14 | 0.058 | 1.47 | 30 | 1 |
| 14 | 0.057 | 1.45 | 30 | 1 |
| 14 | 0.058 | 1.47 | 30 | 0.5 |
| average | 0.06 | 1.46 | | 1 |

Results for the above Table are shown graphically in FIG. 6.

| | M. Film | C. Film | Exp. | |
|---|---|---|---|---|
| Sample | Thick (in) | Thick (mm) | Time (sec) | Rating |
| F | 0.062 | 1.57 | 30 | 1 |
| F | 0.059 | 1.50 | 30 | 2 |
| F | 0.062 | 1.57 | 30 | 1.5 |
| average | 0.06 | 1.55 | | 1.5 |
| 15 | 0.06 | 1.52 | 30 | 0.25 |
| 15 | 0.058 | 1.47 | 30 | 0.25 |
| 15 | 0.058 | 1.47 | 30 | 0.25 |
| average | 0.06 | 1.49 | | 0 |
| 16 | 0.062 | 1.57 | 30 | 0.25 |
| 16 | 0.059 | 1.50 | 30 | 0.25 |
| 16 | 0.06 | 1.52 | 30 | 0.25 |
| average | 0.06 | 1.52 | | 0 |

Results for the above Table are shown graphically in FIG. 6.

The commercial samples had cured tackiness ratings after a 5 second radiation exposure of 2 for sample C, 4 for sample D, 3.5 for sample E and 1 for sample F. The cured tackiness ratings after a 30 second radiation exposure were essentially the same; 2 for sample C, 4 for sample D, 3.5 for sample E and 1.5 for sample F.

Adding tack lessening component 1 decreased cured tack by about one half in almost every formulation. Adding TPGDA and tack lessening agent 2 decreased cured tack about the same as tack lessening agent 1, about one half.

The data shows that tack lessening components can surprisingly reduce tackiness of the cured composition over a range of radiation curable formulations. Tack lessening agent 1, which has (meth)acrylate functionality, reduces tack of the cured surface substantially. Tack lessening component 2, a surface wetting agent with no (meth)acrylate functionality, can also surprisingly reduce tack of the cured surface. Using a multi (meth)acrylate functional diluent does not reduce tack of the cured surface. However, using a combination of tack lessening component 2 and a multi (meth)acrylate functional diluent can synergistically reduce tack of the cured surface even more as compared to only using tack lessening agent 2.

### Example 3

Additional radiation curable compositions were prepared using the formulations in the below Table. All amounts are in wt. % by weight of the composition.

| | | | |
|---|---|---|---|
| material | 17 | 18 | 19 |
| urethane acrylate polymer¹ | 30 | 30 | 30 |
| urethane acrylate polymer² | 15 | 15 | 15 |
| urethane acrylate polymer³ | 8 | 8 | 7 |
| diluent⁴ | 8 | 8 | 7 |
| diluent⁵ | 17.5 | 16.5 | 15.5 |
| diluent⁶ | 7 | 7 | 6 |
| diluent⁷ | 5 | 5 | 5 |
| diluent⁸ | 3.5 | 3.5 | 3.5 |
| diluent⁹ | 0 | 1 | 5 |
| tack lessening component¹⁰ | 1 | 1 | 1 |
| photoinitiator¹¹ | 1.5 | 1.5 | 1.5 |
| photoinitiator¹² | 2.5 | 2.5 | 2.5 |
| additive¹³ | >0.1 | >0.1 | >0.1 |
| additive¹⁴ | 1 | 1 | 1 |

¹polyether urethane acrylate oligomer having a viscosity of 26,000 cP at 60° C. and an acrylate functionality of about 2, available from Dymax
²polyether urethane acrylate oligomer having a viscosity of 13,000 cP at 60° C. and an acrylate functionality of about 2, available from Dymax
³aliphatic urethane acrylate oligomer having a molecular weight of about 1,500 g/mole, a viscosity of 2,500 to 4,000 cP at 60° C. and an acrylate functionality of about 2, available from IGM Resins
⁴isobornyl acrylate
⁵dimethylacrylamide
⁶tetrahydrofurfuryl acrylate
⁷trimethylolpropane triacrylate
⁸Sipomer b-CEA available from Solvay
⁹pentaerythritol tetraacrylate
¹⁰BYK UV 3505
¹¹Hydroxycyclohexylphenylketone 184
¹²Trimethylbenzoyl diphenyl phosphine oxide
¹³optical brightener, Tinopal OB CO available from BASF.
¹⁴gamma-glycidoxypropyftrimethoxysilane (GLYMO g-GPTMS) available as Silquest A-187 from Momentive Performance Materials.

Multiple samples of each composition were placed on a microscope slide. Samples of each composition were cured by exposure to radiation as listed in the below Table and subsequently tested for tack free properties using the previously described cured sample tack test; the results were averaged with the averaged values being rounded. Results are shown in the Tables below.

| material | 17 | 18 | 19 | C¹ |
|---|---|---|---|---|
| Appearance | t-h² | t-h² | t-h² | t-ly³ |
| Form @ 25° C. | liquid | liquid | liquid | liquid |
| Viscosity (cP @ 25° C.) | 1535 | 1728 | 2033 | 530 |
| Elongation (%) | NT⁴ | NT⁴ | NT⁴ | 220 |
| Strength 0.5 second exposure (psi) | 3261 | 2965 | 2788 | 2605 |
| Strength 0.1 second exposure (psi) | 1579 | 1031 | 554 | 78.7 |
| Strength 0.05 second exposure (psi) | MC⁵ | MC⁵ | MC⁵ | MC⁵ |
| Strength 0.01 second exposure (psi) | NC⁶ | NC⁶ | NC⁶ | NC⁶ |
| Tack 2 second exposure | 0 | 0 | 0 | 1 |
| Tack 1 second exposure | 0 | 0 | 0 | 3 |
| Tack 0.5 second exposure | 0 | 1 | 0 | NT⁷ |
| Tack 0.25 second exposure | 2 | 1 | 1 | NT⁷ |
| Tack 0.1 second exposure | 4 | 4 | 4 | NT⁷ |

¹Loctite 3341, a radiation curable composition available from Henkel Corporation, US. This sample did not include a tack lessening component.
²transparent to hazy liquid
³transparent to light yellow liquid
⁴not tested but believed to be greater than 100%
⁵marginally cured, the polycarbonate specimens remained bonded by the cured composition after exposure to radiation but had too little bond strength for a repeatable measurement on the tensile test apparatus.
⁶not cured, the polycarbonate specimens were not bonded by the composition after exposure to radiation
⁷not tested

Samples 17-19 again illustrate the surprising benefit of adding tack reducing compound even when the radiation curable composition is exposed to actinic radiation for extremely short times.

Samples 17-19 used a combination of different oligomers as well as a combination of monomers with different acrylate functionality. Use of these combinations provided low viscosity in view of the high viscosity oligomers in the composition; good bond strength even at the very short 0.1 second exposure time and low tack even at the very short exposure time of 0.25 seconds. The cured samples were subjectively flexible and are expected to have elongations in excess of 100%.

The cured sample flexibility is surprising as the composition comprises trifunctional trimethylolpropane triacrylate and quad functional pentaerythritol tetraacrylate. High functionality diluents would be expected to crosslink at each of the acrylate functional groups leading to a highly crosslinked product with little flexibility. For this reason, high functionality acrylate monomers would not be chosen for use in a composition that must cure to a flexible condition. Without being held to any theory, the inventors speculate that at the short exposure times used the multifunctional acrylate monomers contribute to quick curing of the composition are not fully reacted allowing the cured composition to retain flexibility.

What is claimed:

1. A radiation curable composition comprising a polymer having (meth)acrylate functional groups; a diluent having one or more (meth)acrylate functional groups; a tack lessening component; optionally one or more photoinitiators and optionally additives.

2. The composition of claim 1, wherein the tack lessening component comprises an acrylate functionalized polydimethylsiloxane, a non-acrylate functionalized polydimethylsiloxane, or both.

3. The composition of claim 1, wherein the polymer having (meth)acrylate functional groups has a polyisobutylene backbone and is represented by a general formula (1): 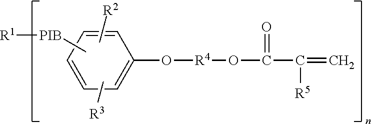
wherein R¹ represents a monovalent or polyvalent aromatic hydrocarbon group or a monovalent or polyvalent aliphatic hydrocarbon group, PIB represents the polyisobutylene backbone containing a plurality of repeating —[CH₂C(CH₃)²]— units, R² and R³ each independently represent a hydrogen atom or a monovalent hydrocarbon group having 1 to 20 carbon atoms, R⁴ represents a divalent hydrocarbon group having 2 to 6 carbon atoms and optionally containing an oxygen atom, R⁵ represents a hydrogen atom, a methyl group, an ethyl group, or a propyl group, and n is any integer of 1 to 6.

4. The composition of claim 1, wherein the polymer having (meth)acrylate functional groups has a polyisobutylene backbone and is represented by a general formula (1): 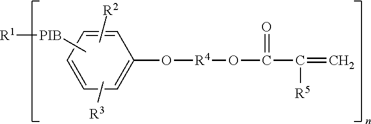
wherein R¹ comprises a divalent phenylene group, PIB represents the polyisobutylene backbone containing a plurality of repeating —[CH₂C(CH₃)₂]— units, R² and R³ are each independently a hydrogen atom or a methyl group or ethyl group, R⁴ is a divalent hydrocarbon group having 3 or 4 carbon atoms and optionally containing an oxygen atom, R⁵ represents a hydrogen atom or a methyl group, and n is any integer of 1 to 6.

5. The composition of claim 1, wherein the polymer comprises a first polyether urethane acrylate oligomer having a viscosity greater than 20,000 cP at 60° C. and a second polyether urethane acrylate oligomer having a viscosity less than 20,000 cP at 60° C.

6. The composition of claim 1, wherein the diluent having one or more (meth)acrylate functional groups comprises 0 to 45 wt. % of a first diluent having a single acrylate functional group; 0 to 20 wt. % of a second diluent having two acrylate functional groups; 0 to 20 wt. % of a third diluent having three acrylate functional groups; and 0 to 20 wt. % of a fourth diluent having four or more acrylate functional groups.

7. The composition of claim 1, wherein the polymer comprises a first urethane acrylate polymer having a viscosity greater than 20,000 cP at 60° C., a second urethane acrylate polymer having a viscosity less than 20,000 cP at 60° C. and a third urethane acrylate polymer having a viscosity less than 6,000 cP at 60° C., and the polymers are present in a ratio of 3.5-4.5 parts first polymer to 1.5-2.5 parts second polymer to 0.5 to 1.5 parts third polymer, the parts being by weight of the total polymer content in the composition.

8. The composition of claim 1, wherein the diluent comprises a singly acrylate functional reactive diluent, a tri acrylate functional reactive diluent and a tetra acrylate functional reactive diluent and the reactive diluents are in a ratio of 4.5-7.5 parts singly acrylate functional reactive diluent to 0.5-1.5 parts tri acrylate functional reactive diluent to 0.5-1.5 parts tetra acrylate functional reactive diluent, the parts being parts by weight of the total reactive diluent content in the composition.

9. The composition of claim 1, wherein the diluent comprises as reactive diluents isobornyl acrylate, dimethylacrylamide and tetrahydrofurfuryl acrylate and the diluents are present in a ratio of 1-2 parts isobornyl acrylate to 2.5 to 3.5 parts dimethylacrylamide to 1 to 2 parts tetrahydrofurfuryl acrylate, the parts being parts by weight of the total reactive diluent content in the composition.

10. The composition of claim 1, wherein the diluent comprises as reactive diluents isobornyl acrylate, dimethylacrylamide, tetrahydrofurfuryl acrylate, a tri acrylate functional reactive diluent and a tetra acrylate functional reactive diluent, and the reactive diluents are present in a ratio of 1-2 parts isobornyl acrylate to 2.5 to 3.5 parts dimethylacrylamide to 1 to 2 parts tetrahydrofurfuryl acrylate to 0.5-1.5 parts tri acrylate functional reactive diluent to 0.5-1.5 parts tetra acrylate functional reactive diluent, the parts being parts by weight of the total reactive diluent content in the composition.

11. An article comprising the composition of claim 1 disposed between a first part bonding surface and a second part bonding surface.

12. The article of claim 11 wherein the composition is cured after exposure to radiation so that cured reaction products of the composition bond the first part bonding surface to the second part bonding surface.

13. The article of claim 11 wherein the first part and the second part are each flexible.

14. The article of claim 11 wherein the first part and the second part are each flexible and the first part bonding surface and the second part bonding surface are independently selected from acrylic polymer, urethane polymer, metal foil, metal wire and rubber.

15. The article of claim 11 wherein the first part and the second part are bonded at discrete points on the first bonding surface and the second bonding surface with the remainder of the first bonding surface and the second bonding surface remaining substantially free of cured reaction products.

16. A method of lessening tack of an at least partially cured polymer composition, comprising:
providing a radiation curable formulation including a (meth)acrylate functional polymer;
providing a tack lessening component comprising an acrylate functionalized polydimethylsiloxane, a non-acrylate functionalized polydimethylsiloxane, or both;
combining the radiation curable formulation and the tack lessening component to form a radiation curable composition; and
exposing the radiation curable composition to radiation to cure the composition, wherein cured reaction products of the composition have a lower tack rating than cured reaction products of the radiation curable formulation.

17. The method of claim 16 wherein the tack lessening component comprises a combination of an acrylate functionalized polydimethylsiloxane and TPGDA, a combination of a non-acrylate functionalized polydimethylsiloxane and TPGDA, or a combination of an acrylate functionalized polydimethylsiloxane, a non-acrylate functionalized polydimethylsiloxane and TPGDA.
